(19) United States
(12) Patent Application Publication
(10) Pub. No.: US 2009/0083959 A1
(43) Pub. Date: Apr. 2, 2009

(54) HYDRAULIC VALVE-LASH COMPENSATION ELEMENT

(75) Inventors: Peter Sailer, Erlangen (DE); Oliver Schnell, Veitsbronn (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/233,118

(22) Filed: Sep. 18, 2008

(30) Foreign Application Priority Data
Sep. 29, 2007 (DE) 102007046829.8

(51) Int. Cl. B23P 19/04

(52) U.S. Cl. 29/213.1; 123/90.55

(57) ABSTRACT

A method for assembling a control valve in a hydraulic valve-lash compensation element, which is constructed for the control drive of an internal combustion engine as a reverse spring element is provided. According to the method, the compensation element is preassembled with a control valve spring (10), a ball (19), and a valve cap (20) of the control valve (11), so that the ball lift (21) caused by the construction of the control valve (11) is greater than a desired value required for the function of the element, after which the actual state of the ball lift (21) is measured and then the ball lift (21) is adjusted by deformation of the valve cap base acting as a contact surface (23) for the ball (19), in order to obtain the desired value of the ball lift (21) of the compensation element. In this way, for all of the compensation elements of the motor, the setting of the no-load lift to a constant value having only very small tolerances can be achieved.

### CROSS-REFERENCE TO RELATED APPLICATIONS

This application claims the benefit of German application DE 10 2007 046 829.8, filed Sep. 29, 2007, which is incorporated herein by reference as if fully set forth.

### BACKGROUND

The invention relates to a method for mounting a control valve in a hydraulic valve-lash compensation element, which is constructed for the control drive of an internal combustion engine as a reverse-spring element, comprising a cylindrical housing, a cylindrical piston guided in this housing with sealing clearance, and the control valve, which is arranged between a low-pressure chamber of the piston and a high-pressure chamber of the housing on a piston base, and a closing body, which is formed as a ball and which, for the construction of a lift in the closing direction against the effect of a control valve spring, can contact against a valve seat surrounding an axial borehole of the piston base and, in the opening direction, can contact against a contact surface of a valve cap surrounding the closing body.

Hydraulic valve-lash compensation elements are used for compensating the clearance formed due to wear or heat expansion during the transmission of the cam lift from a camshaft to a gas-exchange valve of the internal combustion engine between the transmission elements. Through the use of the compensation element, a low-noise and low-wear operation of the valve drive and the greatest possible matching of the cam lobe with the lift of the gas-exchange valve should be achieved.

Such a compensation element has a control valve constructed as a non-return valve, which has a closing body, for example, a ball, and a control valve spring that applies a force on the closing body. In the standard configuration of the control valve, the control valve spring applies a force on the closing body in the closing direction. Therefore, the control valve is predominantly closed and a no-load lift of the valve-lash compensation element is eliminated. Typical values of the ball lift of the compensation elements of the standard configuration have a tolerance width of approximately ±0.06 mm.

Compensation elements, whose control valve spring applies force onto the closing body in the opening direction, are designated as reverse-spring elements due to the inverted arrangement of the control valve spring. These exert a positive influence on the thermodynamics, the pollutant emissions, and the mechanical load on the internal combustion engine and are being used to an increasing degree. For reverse-spring elements, the ball-lift tolerance is considerably smaller than in the standard elements, and equals, for example, ±0.01 mm.

In the standard configuration, the control valve is predominantly closed in the base-circle range of the cam due to the spring force of the control valve spring. For a reverse-spring element, however, the control valve is held open in this base-circle region by the force of the valve spring. Because such an element can be closed at first by the hydrodynamic and hydrostatic forces by the lubricating oil flow introduced at the beginning of the cam lobe and flowing from the high pressure chamber to the low pressure chamber, the element always has a no-load lift before the beginning of the valve lift of the gas exchange valve. The magnitude of the no-load lift depends on the length of the closing time of the control valve at each engine speed, while the closing time depends, in turn, on the viscosity/density of the lubricating oil, which is used here, in a known way, as a hydraulic medium. For closing the control valve of a reverse spring element, a so-called critical lubricating oil velocity is required. This depends on the lubricating oil viscosity and thus on the lubricating oil temperature.

Reverse spring elements of the type named above are known, for example, from the publications DE 10 2005 010 711 A1 and EP 1 298 287 A2. These show a compensation element, in which, as the closing body, the control valve has a ball, which is arranged in an axial borehole of the piston.

In reverse spring elements, the closing body of the control valve is open in the base circle of the cam. For closing the control valve, a volume flow of hydraulic medium, which causes a pressure difference on the closing body, must flow past the closing body, by which the volume flow closes the control valve. Due to manufacturing tolerances, if there are several valve-lash compensation elements in one motor, different no-load lifts can result. The reverse spring elements according to the known state of the art have different no-load lifts during motor operation, which have a negative effect on the motor behavior.

### SUMMARY OF THE INVENTION

The invention is based on the objective of providing, for the installation of the valve-lash compensation elements in a motor, a behavior that allows it to guarantee a uniform no-load lift behavior in all of the compensation elements.

This object is met according to the invention in that the compensation element with the control valve spring, the ball of the control valve, and the valve cap are each preassembled so that the ball lift caused by the construction of the control valve is greater than its desired value necessary for the function of the element, after which the actual state of the ball lift is measured and then the ball lift is adjusted by deformation of of the valve cap base acting as a contact surface for the ball, in order to obtain the desired value of the ball lift of the compensation element. In this way, for all of the compensation elements of the motor, the setting of each no-load lift to a constant value having only very small tolerances can be achieved.

### BRIEF DESCRIPTION OF THE SEVERAL VIEWS OF THE DRAWINGS

One embodiment of a valve-lash compensation element using the invention is shown in the drawing and is described in more detail below. Shown are:

FIG. 1 is a longitudinal section view the piston region of the valve-lash compensation element according to the invention, and

FIG. 2 is a longitudinal section view of a known valve-lash compensation element.

### DETAILED DESCRIPTION OF THE PREFERRED EMBODIMENTS

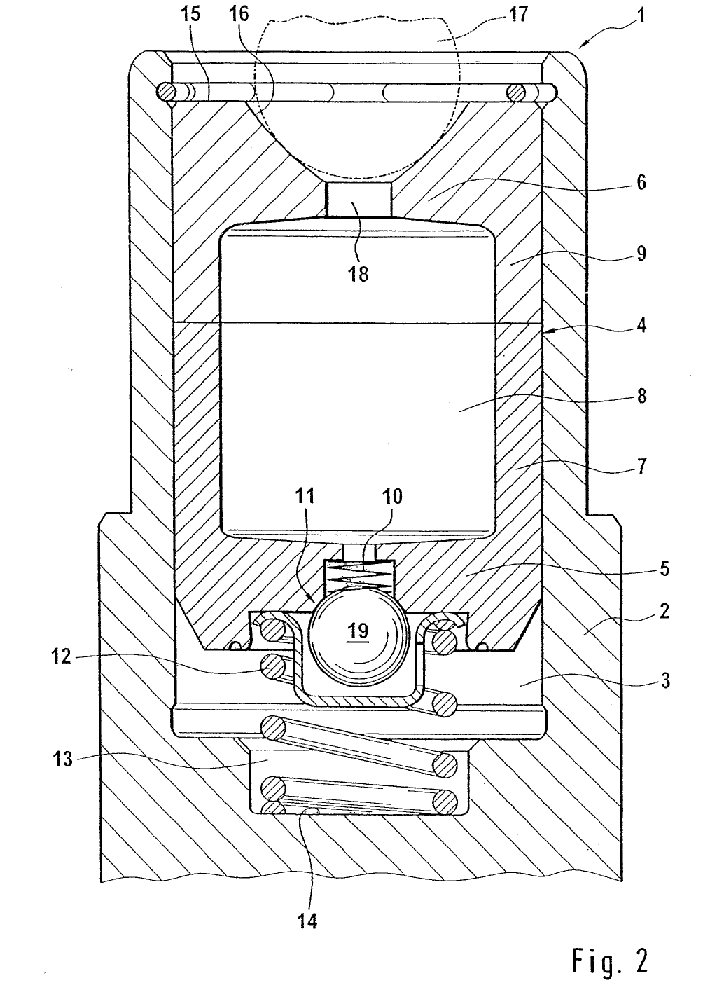

The valve-lash compensation element shown in FIG. 2 is constructed as a hydraulic roller tappet 1. This has a rotationally symmetric housing 2 with a not-shown roller arranged on the bottom end. The housing 2 has a stepped pocket hole, which forms a high-pressure chamber 3 and in which a hollow cylindrical piston 4 is guided with sealing clearance. The piston 4 has a lower piston base 5 and an upper piston base 6. It is divided horizontally into a piston bottom part 7 and a piston top part 9. Below the lower piston base 5 is the high-pressure chamber 3. Above the lower piston base 5 is a low-pressure chamber 8, which is formed by the inner chamber of the piston and which is used as an oil storage space.

The high-pressure chamber 3 is connected to the low-pressure chamber 8 through a central axial borehole, which is arranged in the lower piston chamber 5. It is part of a control valve 11 provided with a control-valve spring 10. This extends into the high-pressure chamber 3 underneath the lower piston base 5. A compression spring 12 is supported in a central recess 13 on the base 14 of the high-pressure chamber 3. It applies force on the piston 4 and thus on the entire valve drive with its compression force. The upper piston base 6 has, on its outer surface 15, a central conical hollow 16 for guiding, for example, the ball-shaped end 17 of a not-fully-shown tappet push rod. Another axial borehole 18, which is located in the upper piston base 6, establishes the connection of the low-pressure chamber 8 to the lubricating oil supply of the valve drive. The closing body of this compensation element is a ball 19.

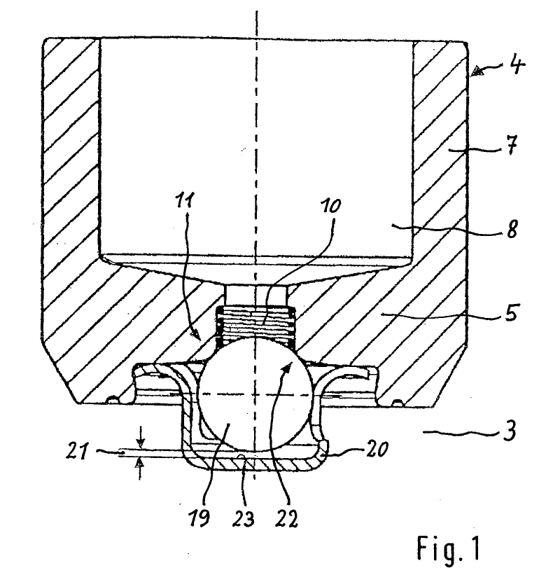

The piston region shown in FIG. 1 is provided for a valve-lash compensation element, which is created by the method according to the invention. It essentially matches structurally with the piston region of the known compensation element according to FIG. 2, so that the same reference symbols are used for the same features corresponding to each other and the description of FIG. 2 is referenced. The ball 19 in FIG. 1 is guided within the axial borehole of the lower piston base 5 in a valve cap 20 which surrounds it. When a piston lift 21 acts in the closing direction of the control valve 11, the ball 19 comes in contact with a valve seat 22, which surrounds the axial borehole of the piston base 5. When the piston lift 21 acts in the opening direction due to the effect of the control valve spring 10, the movement of the ball 19 is limited by a contact surface 23, which is the inner surface of the base of the valve cap 20.

Before the beginning of the motor operation, the ball 19 is held on the contact surface 23 due to the effect of the control valve spring 10. After the beginning of the motor operation and the resulting effect on the cam lobe on the compensation element, the ball 19 is moved toward the valve seat 22 by hydrodynamic and hydrostatic forces due to the hydraulic medium flowing from the high-pressure chamber 3 to the low-pressure chamber 8 against the effect of the control valve spring 10 until the control valve 11 is closed. During the movement of the ball 19 toward the valve seat 22, the compensation element exerts a no-load lift. It can then cause a valve lift of the gas-exchange valve only when the control valve is closed.

When the compensation element is assembled, the setting of a certain desired no-load lift is reached according to the invention only in that the valve cap base is adjusted with the contact surface 23 through deformation. For this purpose, for example, in the base of the valve cap 20, an outwardly concave spherical cap is impressed until the desired no-load lift is produced in later operation of the compensation element.

### LIST OF REFERENCE SYMBOLS

1 Roller tappet
2 Housing
3 High-pressure chamber
4 Piston
5 Lower piston base
6 Upper piston base
7 Piston bottom part
8 Low-pressure chamber
9 Piston top part
10 Control valve spring
11 Control valve
12 Compression spring
13 Recess
14 Base
15 Outer surface
16 Conical hollow
17 Ball-shaped end
18 Axial borehole
19 Ball
20 Valve cap
21 Ball lift
22 Valve seat
23 Stop surface

1. Method for assembling a control valve in a hydraulic valve-lash compensation element, which is constructed for a control drive of an internal combustion engine as a reverse-spring element, with a cylindrical housing, a piston guided in the housing with sealing clearance, and the control valve, which is arranged between a low-pressure chamber of the piston and a high-pressure chamber of the housing on a piston base and a closing body formed as a ball, which can contact, via a ball lift movement in a closing direction against the effect of a control valve spring, a valve seat surrounding an axial borehole of a piston base and, in the opening direction, a contact surface of a valve cap surrounding the closing body, the method comprising:
preassembling the compensation element with the control valve spring, the ball of the control valve, and the valve cap, in such a way that the ball lift created by the construction of the control valve is greater than a desired value required for a function of the element;
measuring the ball lift; and
adjusting the ball lift by deforming the valve cap base that acts as the contact surface for the ball to obtain the desired value of the ball lift of the compensation element.
